(19) United States
(12) Patent Application Publication
(10) Pub. No.: US 2008/0027874 A1
(43) Pub. Date: Jan. 31, 2008

(54) System and method for facilitating secure transactions over communication networks

(76) Inventors: Bernard de Monseignat, Monte Carlo (MC); David Thieme, Brussels (BE)

Correspondence Address: BAKER & MCKENZIE LLP, 1114 AVENUE OF THE AMERICAS, NEW YORK, NY, 10036, US

(21) Appl. No.: 11/493,097

(22) Filed: Jul. 26, 2006

(51) Int. Cl. G06Q 99/00

(52) U.S. Cl. 705/74

(57) ABSTRACT

A user activates the transaction facilitation system from an online banking homepage. Thereafter, communication is performed over a secure communication network. User and transaction type information are received and a unique transaction number is generated. Product information from a vendor is provided to the user, and selected product information is received from the user. Selected transaction information and the transaction number are transmitted to the user's financial institution, and transaction confirmation information is received from the financial institution. A purchase order and the transaction number are transmitted to the vendor, and a confirmation of the purchase order is received from the vendor. An indication of the confirmation of the purchase order, the transaction number, and a customer relations management password are transmitted to the financial institution. Failing successful delivery or any other transactional problems, the user may go directly to free of charge customer relations management services for resolution.

### CROSS-REFERENCE TO RELATED APPLICATIONS

The present invention claims priority from provisional application No. 60/702,891 filed on 26 Jul. 2005, which is incorporated herein in its entirety by reference.

### FIELD OF THE INVENTION

The present invention relates to data processing systems and methods, and in particular to transaction data processing systems and methods for facilitating financial transactions over communication networks in a way that protects the privacy and identity of users while securing efficient settlement of the transactions.

### BACKGROUND OF THE INVENTION

The quantity and value of transactions performed using data communication networks, such as purchase transactions involving goods and/or services, have increased dramatically in recent years. These increases have paralleled the growth and adoption of public communication networks, most prominently the Internet, and the use of data communication networks for transactions is widely expected to increase in volume and scope.

Conventional transactions performed over data communication networks require transmission and receipt of various types of information, including for example information identifying goods and/or services, price information, as well as identification and financial information such as information identifying purchasers and vendors, financial institution identification information, account information, and the like. Transmission of this identification and financial information presents a potential security problem, and this security problem is particularly significant when a transaction is performed via a public communication network such as the Internet.

Insecure features of public data communication networks may allow interception of financial and identification information by parties having malicious or criminal motives. The information may additionally be used to monitor purchaser activities and preferences, thus revealing personal characteristics, tastes, choices, profiles, and the like, which the purchaser may prefer to keep confidential. The information may also be used to fraudulently assign transaction costs, resulting in embezzlement of assets or misappropriation of funds. Additionally, vendors may misuse or allow access to the financial and identification information in their custody as a result of the transactions, and may intentionally or inadvertently allow violation of a purchaser's privacy rights in the information.

Accordingly, there is a need for systems and methods that enable purchasers and users of communication networks to perform transactions for goods and services with greater security and privacy protection, and that enable the secure storage and maintenance of financial and identification information after performance of the transactions.

### SUMMARY OF THE INVENTION

An aspect of the present application provides for a method of facilitating a secure transaction over communication networks, comprising the steps of receiving information associated with a user via a secure communication network, generating a unique transaction number, receiving transaction type information via the secure communication network, providing product information from a computer system of a vendor to the user via the secure communication network, receiving selected product identification information from the user via the secure communication network, transmitting selected transaction information and the generated unique transaction number to a financial institution of the user via the secure communication network, receiving transaction confirmation information from the financial institution of the user via the secure communication network, transmitting a purchase order and the generated unique transaction number to the vendor via the secure communication network, receiving a confirmation of the purchase order from the vendor via the secure communication network, and transmitting an indication of the confirmation of the purchase order, the transaction number, and a customer relations management password to the financial institution of the user.

A further aspect of the present application provides for a method of facilitating a secure transaction over communication networks, comprising the steps of receiving information associated with a user via a secure communication network, receiving information associated with a vendor via the secure communication network, receiving information associated with the transaction via the secure communication network, generating a unique transaction number, transmitting selected transaction information and the generated unique transaction number to a financial institution of the user via the secure communication network, receiving transaction confirmation information from the financial institution of the user via the secure communication network, transmitting a purchase order to the vendor via the secure communication network, receiving a confirmation of the purchase order from the vendor via the secure communication network, transmitting an indication of the confirmation of the purchase order, the transaction number, and a customer relations management password to the financial institution of the user.

A further aspect of the present application provides for a method of facilitating a secure transaction over communication networks, comprising the steps of receiving information associated with a user via a secure communication network, generating a unique transaction number, receiving transaction type information, pre-payment platform identification information, and transaction quantity information from the user via the secure communication network, transmitting transaction information to the pre-payment platform via the secure communication network, receiving transaction confirmation information from the pre-payment platform via the secure communication network, and transmitting an indication of the transaction confirmation, the transaction quantity information, the generated unique transaction number, and a customer relations management password to a financial institution of the user via the secure communication network.

A further aspect of the present application provides for a method of facilitating a secure transaction over communication networks, comprising the steps of receiving information associated with a user via a secure communication network, generating a unique transaction number, receiving transaction type information, pre-payment platform identification information, beneficiary account identification information, and transaction quantity information from the user via the secure communication network, transmitting transaction information to a financial institution of the user via the secure communication network, receiving transaction confirmation information from the financial institution of the user via the secure communication network, transmitting an indication of the transaction confirmation, the generated unique transaction number, and the beneficiary account identification information to a pre-payment platform, and transmitting an indication of the transaction status and a customer relations management password to the financial institution of the user via the secure communication network.

The systems and methods of the present application may include the sending, receiving, and processing of electronic data related to identities and transactions, both via public communication networks such as the Internet and via private communication networks independent of and separate from the Internet. The electronic data transmission and reception performed via the private communication networks may utilize proprietary, dedicated, private, and secure data communication lines.

Additionally, the systems and methods of the present application may be associated with customer relations management (“CRM”) services. The CRM services may include a live-operator call center and/or a help desk, recorded voice message assistance, text-based support, and the like, for resolution of any problems associated with transactions. The problems may arise during performance of transactions, and may include, for example, delayed or incomplete delivery, theft, damage to merchandise, and the like. The CRM services may manage all problems related to the transaction until an ultimate solution is reached that is satisfactory to all parties to the transaction. The CRM services may be provided at no cost, and may be accessed via any method of communication including email, facsimile, telephone, and the like.

All records associated with transactions performed in association with the transaction facilitation systems and methods of the present application may additionally be securely stored and archived under the supervision and/or surveillance of independent inspecting entities, for example, Group Bureau Veritas.

### BRIEF DESCRIPTION OF THE DRAWINGS

The present application can be more fully understood by reading the following detailed description of the presently preferred embodiments together with the accompanying drawings, in which like reference indicators are used to designate like elements, and in which:

FIG. 1 shows a transaction facilitation system according to an exemplary embodiment of the present application;

FIG. 2 is a flow diagram of a method for facilitating a secure transaction according to an exemplary embodiment of the present application;

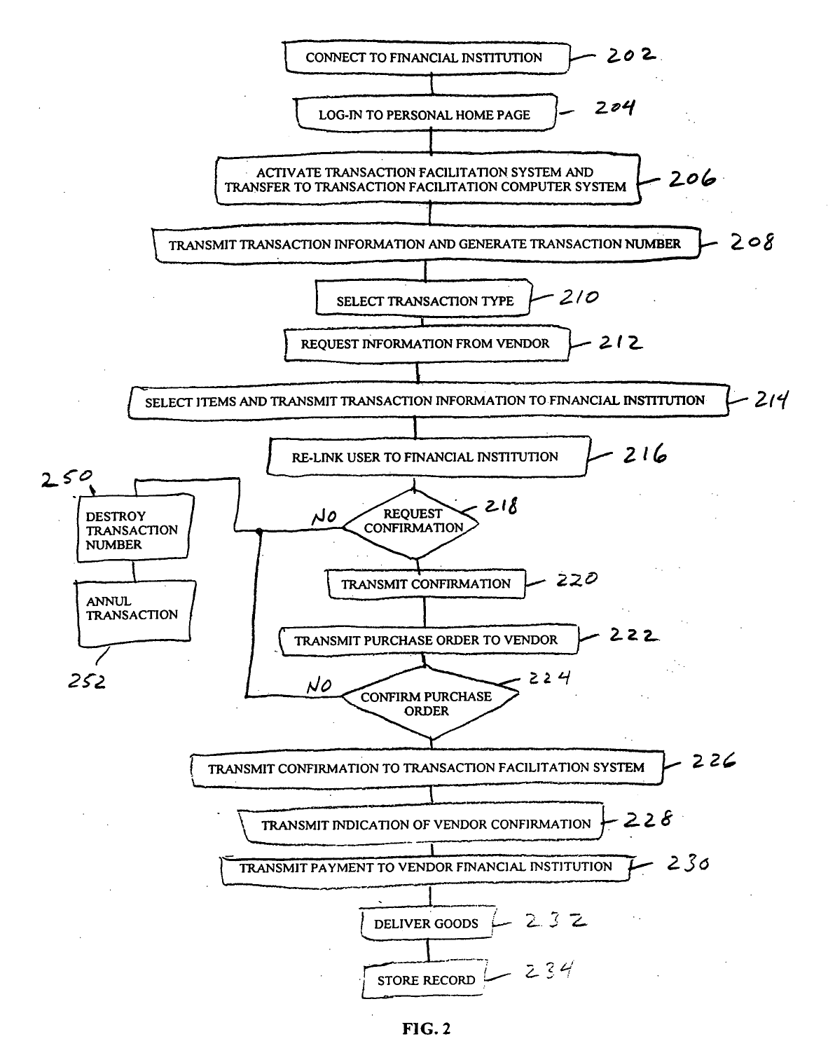

FIG. 3 shows a transaction facilitation system according to an exemplary embodiment of the present application;

FIG. 4 is a flow diagram of a method for facilitating a secure transaction according to an exemplary embodiment of the present application;

FIG. 5 shows a transaction facilitation system according to an exemplary embodiment of the present application;

FIG. 6 is a flow diagram of a method for facilitating a secure transaction according to an exemplary embodiment of the present application;

FIG. 7 shows a transaction facilitation system according to an exemplary embodiment of the present application;

FIG. 8 is a flow diagram of a method for facilitating a secure transaction according to an exemplary embodiment of the present application.

### DETAILED DESCRIPTION OF THE INVENTION

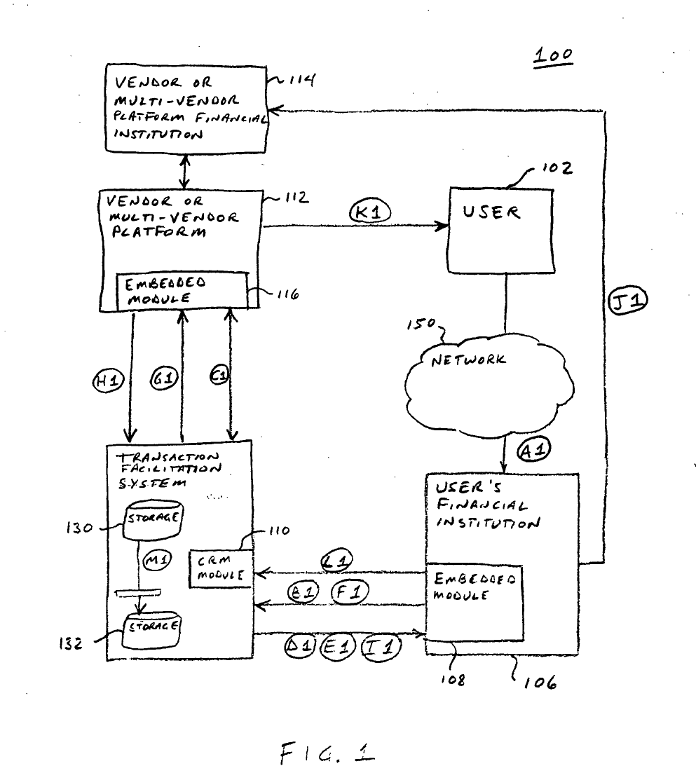

Referring to FIG. 1, an exemplary transaction facilitation system 100 of the present application may include a user computer system 102, a transaction facilitation computer system 104, a vendor computer system 112, a vendor financial institution computer system 114, an embedded facilitation computer system module 116 located at the vendor, a CRM help module 110, a public communication network 150, a computer system of the financial institution of the user 106, an active storage device of the transaction facilitation computer system 104, a secure archive storage device 132, and an embedded facilitation computer system module 108 located at the financial institution of the user.

Communication between the plural computer systems of the present application may be performed via the public communication network 150, and the public communication network 150 may include the Internet. Communication between the plural computer systems may alternatively be performed via one or more dedicated, private communication networks separate from and independent of a public communication network. The financial institutions of the various exemplary embodiments of the present application may include, for example, banks, credit card issuers, debit card issuers, and the like.

As will be understood by one skilled in the art, references herein to computer systems include software applications stored in and/or run by the computer systems, and the computer systems may be managed and/or administered by independent entities. Furthermore, references herein to individual entities should be understood to encompass and include the respective entity as well as agents of the respective entity and/or instruments controlled by the respective entity, such as computer systems, institutions, and the like. Additionally, the plural computer systems of the various exemplary embodiments may be located in geographically remote locations and linked via data communication networks, or may be integrated into one or more components or combinations of components located in close proximity. The various computer system modules of the embodiments of the present application may include software modules stored in and/or run by computer systems, or may include separate, stand-alone computer components that are networked and/or interfaced with other computer systems.

The CRM call center and help module 110 may include a software interface that runs on the transaction facilitation computer system 104, whereby the software interface accepts contact from users, for instance in the form of electronic mail communication, facsimile communication, telephone communication, and the like, and transfers the user to a CRM facility that is staffed by live operators and/or other persons that may assist the user in resolving transaction problems. Alternatively, the user may contact the CRM facility and/or live operator assistants directly.

An exemplary transaction facilitation system of the present application may include software programs or routines stored in and executed by each computer system, and each software program or routine may be capable of performing communication with other computer systems in conjunction with conventional computer communication hardware and software. As will be appreciated by one skilled in the art, the terms “computer system” and “network” as used herein may include a variety of combinations of fixed and/or portable computer hardware, software, peripherals, and storage devices. Generally each computer system identified herein may include at least a processor, a random-access memory, a local or remote storage device, and peripherals such as keyboards, mice, printers, and monitors for enabling input and output of information to and from each computer system. Software routines and/or programs may be embedded and/or stored in the storage devices and run by the processors. Each network identified herein may include wired or wireless communication lines and associated conventional hardware devices used in transmitting, receiving, and routing data, such as routers, switches, hubs, interfaces, and the like.

The hardware and software components of the computer systems of the present application may include and may be included within fixed and portable devices including desktop, laptop, server, personal digital assistant, smart phone, clock, watch, television, compact disc, digital video disc, radio, audio and video recording, replaying, download-capable, and any other suitable communication devices. The devices may include white and brown appliances. The hardware and software components of the system of the present application may also include communication and entertainment devices, and devices for use in a variety of locations including airplanes, automobiles, boats, trains, trucks, hotels, restaurants, public areas, installations, and the like.

Storage devices of the exemplary systems of the present application may include devices for storing data electronically, such as hard drive devices, storage servers, storage-area networks, RAID configurations, optical media drives, holographic media drives, tape media drives, magnetic storage media, flash memory devices, and the like.

The processors of each of the plural computer systems may run software applications including operating systems such as UNIX, BSD, Linux, OS/2, VMS, and Microsoft applications, as well as database applications, web server applications, file server applications, file transfer protocol (“FTP”) server applications, mail server applications, and the like.

The plural computer systems may also each be configured to function as a web server for delivering information via TCP/IP protocol and/or Internet interface. The information transmitted by the web server may include web page information identified by universal resource locators (“URLs”), and formatted in Hyper Text Markup Language (“HTML”) or a similar formatting language in response to requests received via data communication networks. The web page information may also include information formatted using Dynamic HTML (“DHTML”), Extensible Markup Language (“XML”), Java, JavaScript, and the like. Alternatively, the web server may be configured to provide information utilizing Wireless Access Protocol (“WAP”) to a WAP-enabled device such as a cellular telephone, personal digital assistant (“PDA”), and the like. Web server functions may be performed through utilization of web server applications such as Apache, Netscape, and Microsoft web server applications in conjunction with Common Gateway Interface (“CGI”) applications. The CGI applications may perform tasks related to receiving and sending data packets to other computer systems via communication networks, and may additionally perform communication with the database applications in accordance with information received from the communication networks. The CGI applications may include programs written, for example, using programming languages such as C, C++, Java, Perl, Python, and shell scripts. Additionally, the web server applications may incorporate or may be associated with data encryption applications including Secure Socket Layer (“SSL”) and/or Transport Layer Security (“TLS”) applications for providing endpoint authentication and communications privacy using cryptography, and secure shell (“SSH”) applications for encrypted communications, tunneling, forwarding ports, and transferring data files. The web server applications may additionally provide web services, and the web services may be provided via private communication networks and/or public communication networks such as the Internet.

The plural computer systems may additionally run database applications, and the database applications may be utilized to build and manage databases. The database applications may include relational database management systems, such as applications developed by Oracle, IBM, and the like.

Communication between the plural computer systems of the system of the present application may be performed using wired or wireless communication lines, and may be performed using any suitable analog or digital communication protocol including TCP/IP, GSM, GPRS, EDGE, WAP, 3G/UMTS, CDMA, TDMA, and the like. Utilization of computer hardware and software components and performance of communication between the various components is well-known in the art, and will therefore not be described in greater detail herein.

### Internet Purchase Transaction

FIG. 1 illustrates an exemplary transaction facilitation system 100 for processing a transaction between a user and a vendor or multi-vendor platform. As shown as activity A1 in FIG. 1, a user 102 may initiate a transaction by connecting to and/or communicating with the computer system of the user's financial institution 106, at step 202. In an exemplary embodiment, the communication of step 202 may include utilization of a web browser software application running on user computer system 102, and the web browser software application may allow transmission of information to, and receipt of information from, the user's financial institution computer system 106.

As will be understood by one skilled in the art, the communications may include data formatted in a conventional web format such as HTML, DHTML, XML, and the like, and may additionally include information in Java, Javascript, Flash, and any other suitable format. The communication may include display of information within a window displayed by the web browser software application, and the displayed web browser window may include conventional text entry boxes, scrolling animated and/or scrolling menus, buttons, widgets, animations, icons, and other suitable graphical elements to allow the user to communicate with the user's financial institution computer system 106.

In an exemplary embodiment, the user may “log-in” to the user's financial institution computer system 106 via a web site served and/or maintained by the user's financial institution and accessed via the web browser software application at step 204. The log-in procedure may include entering of various pieces of user identification information, and the user identification information may include, for example, user name, user password, user account number, user address and/or telephone number information, and any other suitable information identifying the user. In alternative exemplary embodiments, entry of other identification information may be required during the log-in procedure, such as biometric information including fingerprint information, iris-scan information, voice and voice pattern information, and the like.

Once the user 102 has logged-in as described above, the user may be presented with a personal online banking home page. The personal online banking home page may contain displays of information associated with accounts, payments, fund transfers, and the like, of the user 102. The personal online banking home page may additionally provide an interface to account management software applications and/or account information entry mechanisms to allow the user 102 to manage and modify the user's accounts and funds. A transaction facilitation option may be presented to the user 102 on the personal online banking home page, for instance in the form of a displayed button, icon, scrolling animated menu, text string, or other suitable selectable graphical element. The user 102 may select the transaction facilitation application by clicking on or selecting the graphical element at step 206.

As shown as Activity B1 in FIG. 1, upon selection of the transaction facilitation application, the user's financial institution computer system 106 may transfer the user 102 to the transaction facilitation computer system 104. The transfer may be performed, for instance, through use of and/or by the transaction facilitation computer system module 108. As described above, the transaction facilitation computer system module 108 may include a software application stored in and run by the user's financial institution computer system 106, or may include a separate, stand-alone computer system that is networked and/or interfaced with the user's financial institution computer system 106.

The user may be connected to the transaction facilitation computer system 104 by a dedicated, private communication line that is independent of and separate from a public communication network such as the Internet. In addition to the connection of the user's computer system 102 to the transaction facilitation computer system 104, the user's financial institution computer system 106 and/or the transaction facilitation computer system module 108 may transmit information associated with the desired transaction, at step 208. The transaction information may include one or more of a name of the user's financial institution, a country of domicile of the user's financial institution, and an electronic mail address used by the user for transactions. The transaction facilitation computer system 104 may then generate and assign a one-time transaction number. The one-time transaction number may include any quantity of numerical digits, alphabetical characters, or other appropriate symbols, and may serve as a consistent identifier for the transaction until ultimate conclusion of the transaction, for instance, until delivery of a good or service purchased by the user.

Upon connection to the transaction facilitation computer system 104, the user 102 may be presented with a web page of the transaction facilitation computer system 104. At step 210, the user may then be asked to select a transaction type via the web browser. The available transaction type selections may include, for instance, “financial” or “commercial,” and the selection may be performed via a drop-down scrolling menu, buttons, graphical icons, and the like. Upon selection of a “commercial” transaction type, the user may be presented with a selection of available vendors and/or multi-vendor platforms, for instance via a drop-down scrolling menu, a text listing, graphical icons, and the like. In an exemplary embodiment, an arrangement may be made between each vendor or multi-vendor platform and a maintainer and/or administrator of the transaction facilitation system of the present application. A predetermined list of vendors or multi-vendor platforms may be presented to the user, and contents and/or information contained in the predetermined list may be updated periodically by an automated or manual network updating process, or by some other updating mechanism. Any other suitable transaction type may additionally be used.

At step 212, upon selection of a desired vendor and/or multi-vendor platform, the transaction facilitation computer system 104 may communicate with the vendor and/or multi-vendor computer system 114, as shown as Activity C1 in FIG. 1. In an exemplary embodiment, the communication may include a request for web page information of the vendor and/or multi-vendor platform, and the information received may be displayed in the page displayed by the transaction facilitation computer system 104 and rendered on the web browser viewed by the user 102. The vendor and/or multi-vendor platform web page may be displayed, for instance, in a sub-window or in a portion of the web page displayed by the transaction facilitation computer system 104. In an exemplary embodiment, the communication of Activity C1 may include no identification information of the user 102, such that the user 102 may remain completely anonymous to the vendor and/or multi-vendor platform.

Upon retrieval and display of the web page information of the vendor and/or multi-vendor platform, the user may navigate the displayed vendor and/or multi-vendor web page in a conventional manner utilizing the web browser application. The navigation may include the retrieval and rendering of a plurality of linked web pages, and the display, for instance, of items offered for sale by the vendor and/or multi-vendor platform. The user may browse the web page and items offered by the vendor and/or multi-vendor platform, and may for instance select desired items for purchase. The selection for purchase may include a conventional “check-out” function whereby the selected items are designated for purchase and the user 102 is then directed to a payment option and information-entry web page on the vendor and/or multi-vendor platform web site. Upon conclusion by the user 102 of the desired vendor and/or multi-vendor web site browsing activity, the user 102 may indicate a desire to purchase one or more items at step 214. Upon selection of the items and checking-out by the user 102 as described above, the transaction facilitation computer system 104 may transmit all relevant information related to the transaction to the user's financial institution computer system 106, as shown as Activity D1 in FIG. 1. In an exemplary embodiment, the transmitted transaction information may include, for instance, the one-time transaction number generated at step 208, but may not include information identifying the items selected by the user 102 for purchase. The transmission of the relevant transaction information of step 214 may be performed via a dedicated, private data communication line that is independent of and separate from a public communication network such as the Internet.

Approximately simultaneously with the transmission of transaction information and via a dedicated, private data communication line that is independent of and separate from a public communication network such as the Internet, the user 102 may additionally be re-linked to the user's financial institution computer system 106 at step 216. The user's personal online banking web page may again be displayed to the user 102 via the web browser. The user's personal online banking web page may include a description of the selected transaction, and may present the user 102 with an option to confirm the selected transaction and to request payment authorization from the user's financial institution. The confirmation and payment authorization may be performed, for instance, through utilization of a graphical element, button, text entry, and the like, via the web browser.

Confirmation of the transaction may be requested by the transaction facilitation computer system 104 at step 218, as shown as Activity E1 in FIG. 1. In an exemplary embodiment, transmission of the confirmation of the transaction may be requested by the transaction facilitation computer system 104, for instance, at a predetermined period of time after the transmission of the transaction information in step 214, or at each of a series of predetermined times thereafter. When the transaction is not confirmed, or for any other reason the payment is not authorized, the one-time transaction number may be destroyed at step 250, and the transaction may be automatically cancelled and annulled, at step 252.

As shown as Activity F1 in FIG. 1, when the transaction is confirmed, the user's financial institution computer system 106 may transmit the confirmation and an indication to proceed with the transaction at step 220. In an exemplary embodiment, the transmission of step 220 may be performed via a dedicated, private data communication line that is independent of and separate from a public communication network such as the Internet.

Upon confirmation of the transaction, the transaction facilitation computer system 104 may transmit a purchase order to the vendor computer system 112 at step 222, shown as Activity G1 in FIG. 1. In an exemplary embodiment, the transmission of the purchase order may be performed via a dedicated, private data communication line that is independent of and separate from a public communication network such as the Internet. The purchase order may include an indication that payment authorization has been received from the user's financial institution, and that a quantity of funds has been set aside and associated with the one-time transaction number. This indication may serve to indicate that funds associated with the transaction are available for transmission by the user's financial institution, thereby allowing the vendor to supply goods and/or services associated with the transaction without fear of payment risk.

The vendor may be given a predetermined period of time within which it must respond to the transmission of the purchase order by, for instance, confirming or declining the purchase order. When the vendor declines the purchase order, the one-time transaction number may be destroyed at step 250, and the transaction may be automatically cancelled and annulled at step 252.

As shown in Activity H1 of FIG. 1, when the vendor confirms the purchase order at step 224, a transmission may be made, via a dedicated, private data communication line that is independent of and separate from a public communication network such as the Internet, to the transaction facilitation computer system 104, at step 226. The vendor confirmation may include the one-time transaction number.

The transaction facilitation computer system 104 may transmit an indication of the vendor's confirmation of the purchase order to the user's financial institution computer system 106 via a dedicated, private data communication line that is independent of and separate from a public communication network such as the Internet, at step 228, shown at Activity I1 in FIG. 1. In an exemplary embodiment, the indication transmitted in step 228 may include the one-time transaction number, and a CRM password.

After receipt of the indication of the vendor's confirmation, the user's financial institution computer system 106 may transmit payment associated with the transaction to the vendor's financial institution 114 at step 230, shown as Activity J1 in FIG. 1. The payment may be performed via conventional financial institution payment channels, such as “Swift” and the like. The payment may be accompanied by the generated one-time transaction number.

Upon transmission of the payment, the vendor and/or multi-vendor platform 112 may be informed by the vendor's financial institution 114 that the payment has been transmitted. At step 232, the vendor may then deliver the goods and/or services associated with the transaction to the user 102 in accordance with shipment and/or delivery instructions provided by the user 102, as shown in Activity K1 of FIG. 1.

As shown in FIG. 1 as activity L1, the CRM call center and help module 110 of the transaction facilitation system may be accessed by the user 102 if there is an incomplete or improper performance of the delivery, for example delayed or incorrect delivery of the requested goods and/or services, theft, damage or malfunction of the delivered goods and/or services, and the like. In an exemplary embodiment, the user 102 may contact the CRM call center via the user's financial institution computer system 106, for instance, via an electronic email address and/or communication application accessible through a web page of the user's financial institution. Alternatively, the CRM call center and help module 110 may be accessed via telephone, facsimile, email, postal mail, and the like. In an exemplary embodiment, access and/or utilization of the CRM services may require provision of the CRM password.

A record of each transaction may be generated and stored by the transaction facilitation computer system 104 at step 234, as shown in Activity M1 of FIG. 1. The record may include information corresponding to the transaction including user identity, vendor, purchase amount, purchase date, financial institution, delivery date, and the like. In an exemplary embodiment, a transaction record may be stored for a predetermined period of time, for example 7 years, in a secure database 132 that is not accessible or connected to a public network such as the Internet, and that is not connected to other storage devices 130 of the transaction facilitation computer system 104.

### Online Payment After Checkout on a Vendor Site

In an alternative exemplary embodiment, the transaction facilitation system of the present application may be utilized without first connecting to the user's financial institution computer system 106, and may be used, for instance, in association with payments made after selection of items and check-out of a vendor web site by the user 102.

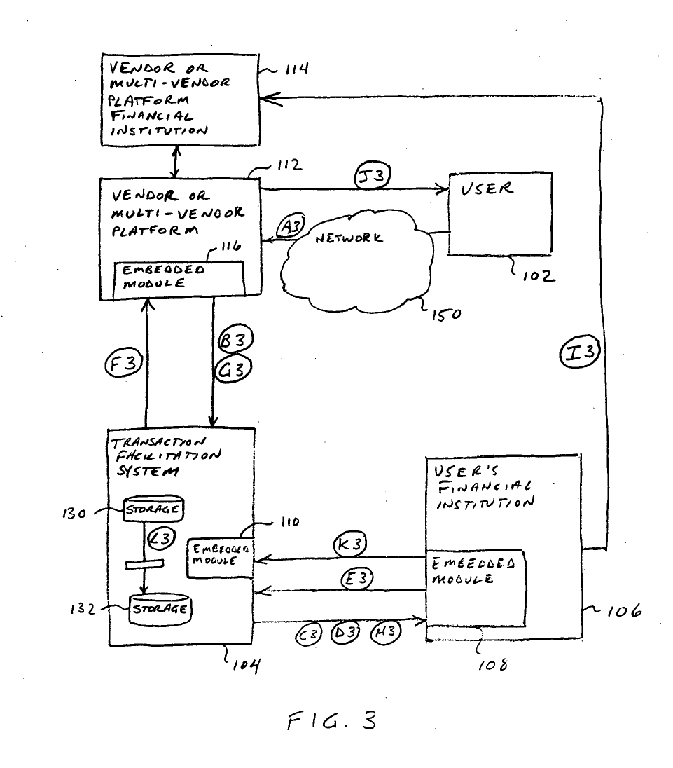

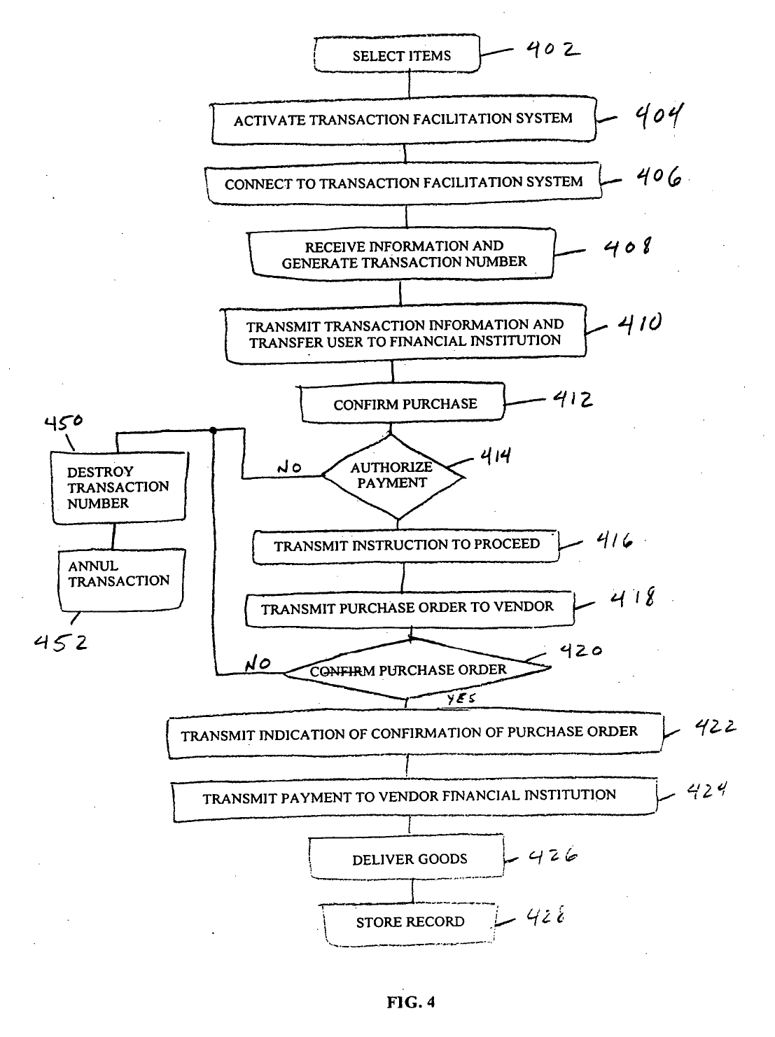

Referring to FIGS. 3 and 4, the user 102 may visit a vendor web site via a public communication network such as the Internet 150, and may browse and shop for one or more desired items, at step 402, as shown in Activity A3 in FIG. 3. The vendor computer system 112 may be connected to the transaction facilitation computer system 104 via a dedicated, private data communication line that is independent of and separate from a public communication network such as the Internet. Additionally, the vendor may be affiliated with an organization that manages and/or administers the transaction facilitation system.

The vendor web site may employ a conventional online shopping web page and associated web application software, and may additionally utilize a “check-out” feature as described above, whereby the user 102 may finalize transaction choices and provide payment and identification information. The vendor computer system 112 may additionally display a transaction facilitation activation button on its shopping web site. Alternatively, the transaction facilitation activation may be selected by the user by clicking on an icon, a scrolling menu, a text string, graphical element or any other suitable activation indication device.

At step 404, upon activation of the transaction facilitation system, the user 102 may be connected to the transaction facilitation computer system 104, as shown in Activity B3, and may communicate with the transaction facilitation computer system 104 via, for instance, a web browser. The transaction facilitation computer system 104 may request information from the user 102, and the requested information may include the name of the user's financial institution, the country of domicile of the user's financial institution, and an electronic mail address used by the user. The transaction facilitation computer system 104 may process the received information, and may return the user 102 to the vendor web site to arrange for alternative payment options when the user's financial institution is not affiliated with the organization that manages and/or administers the transaction facilitation system.

Information associated with the vendor may additionally be collected by the transaction facilitation computer system 104. In an exemplary embodiment, the embedded transaction facilitation module 116 may collect information associated with the vendor, including a name of the vendor, a name and/or address of the vendor's website, a vendor data, a vendor time of transaction, information describing contents of the user's virtual “shopping cart,” an amount of the transaction, and a currency of the transaction.

At step 406, the user 102 may then be connected to the transaction facilitation computer system 104 via a dedicated, private data communication line that is independent of and separate from a public communication network such as the Internet, as shown in Activity B3 in FIG. 3. Additionally, the vendor information collected by the embedded transaction facilitation module 116 may be transmitted to the transaction facilitation computer system 104 via a dedicated, private data communication line that is independent of and separate from a public communication network such as the Internet. Upon receipt of this information, the transaction facilitation computer system may generate and assign a one-time transaction number, at step 408.

As shown in Activity C3 of FIG. 3, the transaction facilitation computer system 104 may transmit the one-time transaction number and relevant transaction details to the user's financial institution computer system 106 via a dedicated, private data communication line that is independent of and separate from a public communication network such as the Internet at step 410. In an exemplary embodiment, the information describing the contents of the user's shopping cart is not transmitted to the user's financial institution computer system 106. Approximately simultaneous with the transmission described above, the transaction facilitation computer system 104 may transfer the user 102 to the user's financial institution computer system 106, where the user 102 may connect to the user's financial institution personal home page. The user 102 may log-in to the user's financial institution personal home page in a conventional manner, for instance by entering a log-in name, password, and the like. After logging-in, the user may be presented with a transaction facilitation system activation icon, scrolling menu, button, or the like, displayed on the user's personal online banking home page. Upon clicking upon or otherwise activating the transaction facilitation activation icon at step 412, the user 102 may confirm the purchase and request payment authorization from the user's financial institution for the transaction. When the financial institution does not authorize the payment, or the payment cannot be performed for any reason at step 414, the one-time transaction number may be destroyed at step 450, and the transaction may be automatically cancelled and annulled, at step 452.

When the payment is authorized at step 414, the user's financial institution computer system 106 may inform the transaction facilitation computer system 104 of the authorization, and may transmit an instruction to proceed with the transaction, at step 416, as shown in Activity E3 in FIG. 3. Thereafter, at step 418, the transaction facilitation computer system 104 may transmit the purchase order to the vendor's computer system 112 via a dedicated, private data communication line that is independent of and separate from a public communication network such as the Internet, and may additionally transmit the one-time transaction number at step 418, as shown in Activity F3 in FIG. 3.

The transmission of the purchase order at step 418 may include an indication that payment authorization has been received from the user's financial institution 106, and that a quantity of funds has been set aside and associated with the one-time transaction number. This indication may serve to indicate that funds associated with the transaction are available for transmission by the user's financial institution 106, thereby allowing the vendor to supply goods and/or services associated with the transaction without fear of payment risk. The vendor may be given a predetermined period of time within which it must respond to the transmission of the purchase order by, for instance, confirming or declining the purchase order. When the vendor declines the purchase order, the one-time transaction number may be destroyed at step 450, and the transaction may be automatically cancelled and annulled, at step 452.

As shown in Activity G3 of FIG. 3, the vendor may confirm the purchase order at step 420 via a dedicated, private data communication line that is independent of and separate from a public communication network such as the Internet, to the transaction facilitation computer system 104. The vendor confirmation may include the one-time transaction number.

The transaction facilitation computer system 104 may transmit an indication of the vendor's confirmation of the purchase order to the user's financial institution computer system 106 via a dedicated, private data communication line that is independent of and separate from a public communication network such as the Internet, at step 422, shown at Activity H3 in FIG. 3. In an exemplary embodiment, the indication transmitted in step 422 may include the one-time transaction number, and a CRM password.

After receipt of the indication of the vendor's confirmation, the user's financial institution computer system 106 may transmit a payment associated with the transaction to the vendor's financial institution 114 at step 424, shown as Activity I3 in FIG. 3. The payment may be performed via conventional financial institution payment channels, such as “Swift” and the like. The payment may be accompanied by the one-time transaction number or by a reference to the one-time transaction number.

Upon transmission of the payment, the vendor and/or multi-vendor platform may be informed by the vendor's financial institution that the payment has been transmitted. At step 426, the vendor may then deliver or provide the goods and/or services associated with the transaction to the user 102 in accordance with shipment and/or delivery instructions provided by the user 102, as shown in Activity J3 of FIG. 3.

As shown in FIG. 3 as activity K3, the CRM call center and help module 110 of the transaction facilitation system may be accessed by the user 102 when there is an incomplete or improper performance of the delivery, for example delayed or incorrect delivery of the requested goods and/or services, theft, damage or malfunction of the delivered goods and/or services, and the like. In an exemplary embodiment, the user 102 may contact the CRM call center via the user's financial institution computer system 106, for instance, via an electronic email address and/or communication application accessible through a web page of the user's financial institution. Alternatively, the CRM call center and help module 110 may be accessed via telephone, facsimile, email, postal mail, and the like. In an exemplary embodiment, access and/or utilization of the CRM services may require provision of the CRM password.

A record of each transaction may be generated and stored by the transaction facilitation computer system 104 at step 428, as shown in Activity L3 of FIG. 3. The record may include information corresponding to the transaction including user identity, vendor, purchase amount, purchase date, financial institution, delivery date, and the like. In an exemplary embodiment, a transaction record may be stored for a predetermined period of time, for example 7 years, in a secure database 132 that is not accessible or connected to a public network such as the Internet, and that is not connected to other storage devices 130 of the facilitation computer system 104.

### Internet Financial Transaction Related to Pre-Payment Platform

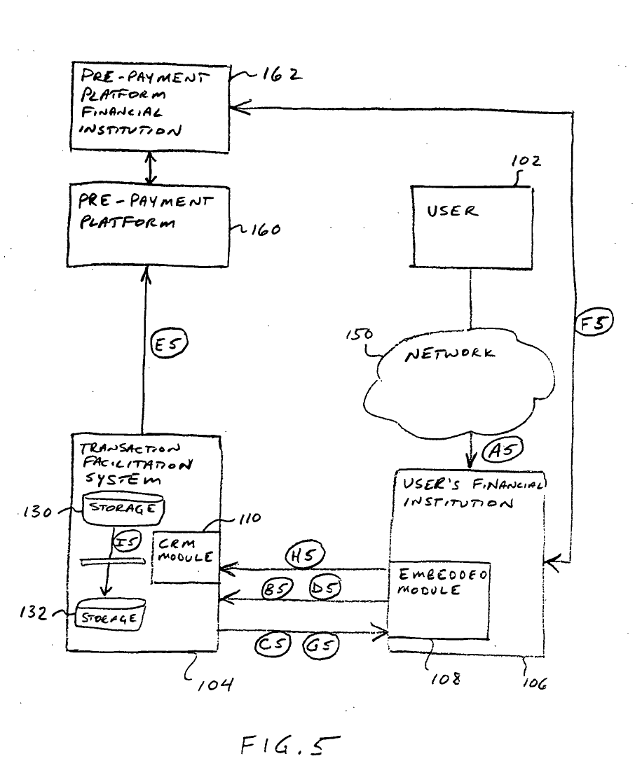

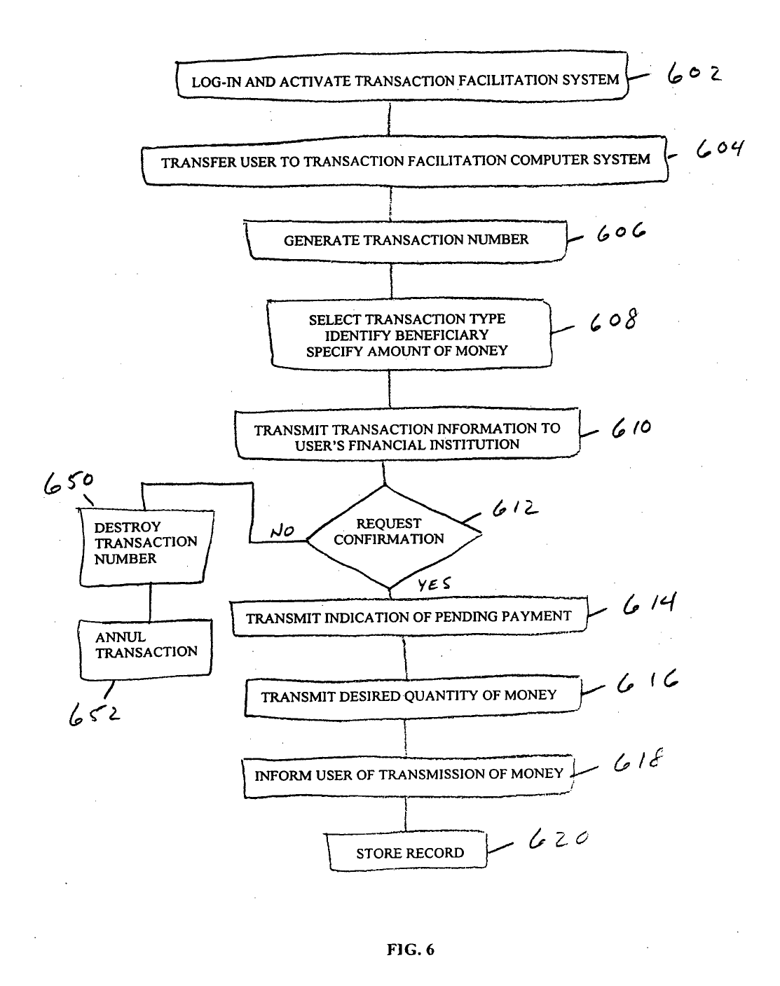

An alternative exemplary embodiment will be described with reference to FIGS. 5 and 6, whereby a user 102 may perform a payment to a pre-payment platform account utilizing the transaction facilitation system of the present application. The pre-payment platform account may be owned by the user 102, or may be owned by a third party. The payment may be performed without disclosure of any of the user's personal and/or financial information to the pre-payment platform entity itself.

At step 602, the user may connect to the web site home page of the user's financial institution, and may log-in to the user's personal online banking home page in a conventional manner, as described above and as shown as Activity A5 in FIG. 5. The log-in procedure may include entering of required on-line banking information, such as a user name and password. Other information may additionally or alternatively be required as part of the log-in process, for instance electronic mail address information, address information, and the like.

A transaction facilitation application activation icon may be presented to the user 102 on the personal online banking home page. In an exemplary embodiment, the activation icon may be a graphical element such as an icon, scrolling menu, or a button, and the graphical element may blink, shift, or move, or be rendered in a unique or oversized font to attract the attention of the user. Alternatively, the activation icon may include a text element, menu, graphical icon, scrolling menu, or other selectable device to allow the user to activate the transaction facilitation system.

At step 604, upon selection of the transaction facilitation application, the user's financial institution computer system 106 may transfer the user 102 to the transaction facilitation computer system 104, as shown as Activity B5 in FIG. 5. The transfer may be performed, for instance, by the transaction facilitation computer system module 108. The user 102 may be connected to the transaction facilitation computer system 104 by a dedicated, private communication line that is independent of and separate from a public communication network such as the Internet. In addition to the connection of the user 102 to the transaction facilitation computer system 104, the user's financial institution computer system 106 and/or the transaction facilitation computer system module 108 may transmit all information required to perform a transaction. This transaction information may include one or more of a name of the user's financial institution, a country of domicile of the user's financial institution, and an electronic mail address used by the user for transactions.

The transaction facilitation computer system 104 may then generate and assign a one-time transaction number to the transaction, at step 606. The one-time transaction number may serve as a consistent identifier for the transaction until ultimate conclusion of the transaction. Upon connection to the transaction facilitation computer system 104, the user 102 may be presented with a transaction facilitation web page via the web browser application. The user 102 may then be asked to select a transaction type via the web browser at step 608. The available transaction type selections may include, for instance, “financial” or “commercial,” and the selection may be performed via a drop-down scrolling menu, buttons, graphical icons, and the like. Upon selection of “financial” transaction type, the user 102 may be asked to specify a sub-category of desired transaction. A listing of available sub-categories may be presented to the user 102, again, for instance, in the form of a drop-down scrolling menu, graphical icons, and the like. The available sub-categories may include “bank,” “pre-payment platform,” and the like. When the user 102 selects the “pre-payment platform” sub-category, the user 102 may additionally be asked to specify whether the desired transaction involves a retrieval of money from an account of the pre-payment platform, or a payment or pre-payment to the pre-payment account. Any other suitable transaction type may alternatively be used. In addition to selection of the payment or pre-payment transaction type, the user 102 may be asked to provide an electronic mail address and/or other suitable identifier of the beneficiary of the payment or pre-payment. The beneficiary identifier entered may thereafter serve as an identifier of the account to be credited by the payment or pre-payment transaction. After providing the beneficiary identifier, the user 102 may specify a quantity of money to be transferred to the identified account.

The transaction facilitation computer system 104 may then transmit, via a dedicated, private data communication line that is independent of and separate from a public communication network such as the Internet, all relevant information related to the transaction to the user's financial institution computer system 106 at step 610. The transmission of the transaction information may include, for instance, the one-time transaction number, along with the desired quantity of money to be transferred to the identified account.

The transaction facilitation computer system 104 may request confirmation of the transaction and instruction to proceed from the user's financial institution computer system 106, at step 612, as shown in Activity C5 in FIG. 5. Confirmation of the transaction may depend upon, for instance, a determination by the user's financial institution computer system 106 that sufficient funds are available for transfer. When the user's financial institution computer system 106 does not confirm the transaction, or the transaction cannot be performed for any other reason, the one-time transaction number may be destroyed at step 650, and the transaction may be automatically cancelled and annulled, at step 652.

As shown as Activity D5 in FIG. 5, when the transaction is confirmed by the user's financial institution computer system 106, the user's financial institution computer system 106 may transmit the confirmation and indication to proceed with the transaction to the transaction facilitation computer system. In an exemplary embodiment, the transmission of the confirmation may be performed via a dedicated, private data communication line that is independent of and separate from a public communication network such as the Internet.

Upon confirmation of the transaction, the transaction facilitation computer system 104 may transmit an indication of a pending payment to the pre-payment platform computer system 160 at step 614, shown as Activity E5 in FIG. 5. In an exemplary embodiment, the transmission of the indication of the pending payment may be performed via a dedicated, private data communication line that is independent of and separate from a public communication network such as the Internet. The transmission of the indication of the pending payment may additionally include the electronic mail address and/or other beneficiary account identifier, along with the one-time transaction number.

As shown in Activity F5 of FIG. 5, a transmission may be made by the user's financial institution computer system 106, via a dedicated, private data communication line that is independent of and separate from a public communication network such as the Internet, of a quantity of money associated with the transaction to the pre-payment platform's financial institution 162 at step 616. The payment may be performed via conventional financial institution payment channels, such as “Swift” and the like. The payment may be accompanied by the one-time transaction number.

At step 618, upon transmission of the quantity of money, the user 102 may be informed by the transaction facilitation computer system 104 that the quantity of money has been transmitted via a dedicated, private data communication line that is independent of and separate from a public communication network such as the Internet, as shown as Activity G5 in FIG. 5. In an exemplary embodiment, the user 102 may be informed by a message presented on the user's personal online banking home page upon the user's financial institution online banking web site, and the message may additionally include a CRM password.

As shown in FIG. 5 as activity H5, the CRM call center and help module 110 of the transaction facilitation system may be accessed by the user 102 if there is an incomplete or improper performance of the transaction. In an exemplary embodiment, the user 102 may contact the CRM call center via the user's financial institution computer system 106, for instance, via an electronic email address and/or communication application accessible through a web page of the user's financial institution. Alternatively, the CRM call center and help module 110 may be accessed via telephone, facsimile, email, postal mail, and the like. In an exemplary embodiment, access and/or utilization of the CRM services may require provision of the CRM password.

A record of each transaction may be generated and stored by the transaction facilitation computer system 104 at step 620, as shown in Activity 15 of FIG. 5. The record may include information corresponding to the transaction including user identity, vendor, purchase amount, purchase date, financial institution, delivery date, and the like. In an exemplary embodiment, a transaction record may be stored for a predetermined period of time, for example 7 years, in a secure database 132 that is not accessible or connected to a public network such as the Internet, and that is not connected to other storage devices 130 of the transaction facilitation computer system 104.

### Internet Financial Transaction for Retrieval of Money from a Pre-Payment Platform

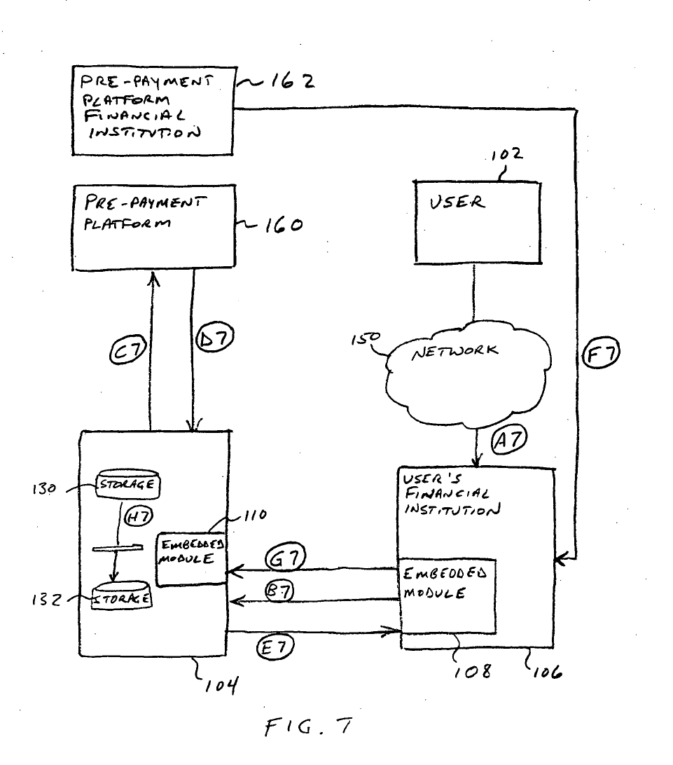

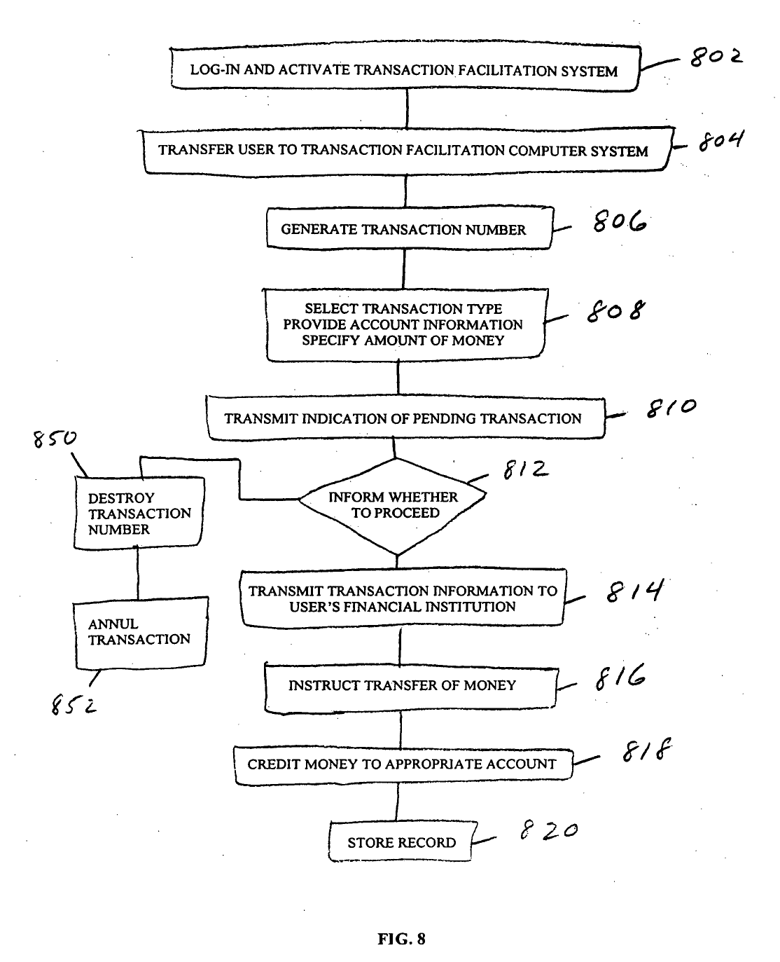

A further alternative exemplary embodiment will be described with reference to FIGS. 7 and 8, whereby the user 102 may retrieve a quantity of money from a pre-payment platform account without disclosure of any personal or financial information other than, for instance, the name of the user's financial institution and the country of domicile of the user's financial institution.

At step 802, the user 102 may connect to the web site home page of the user's financial institution, and may log-in to the user's financial institution personal online banking web site in a conventional manner, as described above and as shown as Activity A7 in FIG. 7. The log-in procedure may include entering of required on-line banking information, such as a user name and password. Other information may additionally or alternatively be required as part of the log-in process, for instance electronic mail address information, address information, and the like.

Upon logging-in, the user 102 may be presented with the user's personal online banking web site home page of the user's financial institution, and a transaction facilitation system activation icon may be presented to the user 102 on the user's personal online banking home page. In an exemplary embodiment, the activation icon may be a graphical element such as a button, and the graphical element may blink, shift, scroll, move, or be rendered in a unique or oversized font, to attract the attention of the user. Alternatively, the activation icon may include a text element, menu, scrolling menu, graphical icon, or other selectable device to allow the user to activate the transaction facilitation system.

At step 804, upon selection of the transaction facilitation application, the user's financial institution computer system 106 may transfer the user 102 to the transaction facilitation computer system 104, as shown as Activity B7 in FIG. 7. The transfer may be performed, for instance, by the transaction facilitation computer system module 108. The user 102 may be connected to the transaction facilitation computer system 104 by a dedicated, private communication line that is independent of and separate from a public communication network such as the Internet. In addition to the connection of the user 102 to the transaction facilitation computer system 104, the user's financial institution computer system 106 and/or the transaction facilitation computer system module 108 may transmit all information required to perform a transaction. This transaction information may include one or more of a name of the user's financial institution, a country of domicile of the user's financial institution, and an electronic mail address used by the user 102 for transactions.

The transaction facilitation may generate and assign a one-time transaction number to the transaction, at step 806. The one-time transaction number may serve as a consistent identifier for the transaction until ultimate conclusion of the transaction.

Upon connection to the transaction facilitation computer system 104, the user 102 may be presented with a transaction facilitation system web page via the web browser application. The user 102 may then be asked to select a transaction type via the web browser at step 808. The available transaction type selections may include, for instance, “financial” or “commercial,” and the selection may be performed via a drop-down scrolling menu, buttons, graphical icons, and the like. Upon selection of the “financial” transaction type, the user may be asked to specify a sub-category of desired transaction. A listing of available sub-categories may be presented to the user 102, again, for instance, in the form of a drop-down scrolling menu, graphical icons, and the like. The available sub-categories may include “bank,” “pre-payment platform,” and the like. When the user 102 selects the “pre-payment platform” sub-category, the user 102 may additionally be asked to specify whether the desired transaction involves a “retrieval of money” from an account of the pre-payment platform, or a “payment or pre-payment” to the pre-payment account. Upon selection of the “retrieval of money” transaction type, the user 102 may then be asked to provide identification information associated with the pre-payment platform account. The identification information may include, for example, a name of the pre-payment platform, an account number, an account name, and/or any other suitable identifier of the pre-payment platform and account. After providing the account identification information, the user 102 may specify a quantity of money to be transferred from the identified account.

At step 810, the transaction facilitation computer system 104 may then transmit an indication of the pending transaction to the pre-payment platform computer system 160 via a dedicated, private data communication line that is independent of and separate from a public communication network such as the Internet, as shown as Activity C7 in FIG. 7. The transmission of the indication may additionally include all relevant information related to the transaction, for instance, the identification information associated with the pre-payment account, the name and country of domicile of the user's financial institution, the one-time transaction number, and the desired quantity of money to be retrieved.

The pre-payment platform computer system 160 may inform the transaction facilitation computer system 104 whether the transaction may proceed at step 812, for example, based upon a determination of whether sufficient funds exist in the identified pre-payment platform account. When the pre-payment platform computer system 160 does not indicate that the transaction may proceed, or when the transaction cannot be performed for any other reason, the one-time transaction number may be destroyed at step 850, and the transaction may be automatically cancelled and annulled, at step 852.

As shown as Activity D7 in FIG. 7, the pre-payment platform computer system 160 may indicate to the transaction facilitation computer system 104 that the transaction may proceed and may authorize the retrieval at step 812. At step 814, after receiving the indication that the transaction may proceed, the transaction facilitation computer system 104 may transmit transaction information to the user's financial institution computer system via a dedicated, private data communication line that is independent of and separate from a public communication network such as the Internet. The transaction information of step 814 may include, for example, the amount of money being transferred to the receiving financial institution and the one-time transaction number associated with the transaction. As shown as Activity E7 in FIG. 7, the transaction facilitation computer system 104 may additionally transmit, via a dedicated, private data communication line that is independent of and separate from a public communication network such as the Internet, the CRM password to the user's financial institution computer system 106. The user's financial institution computer system 106 may display the received CRM password, for instance, on the user's personal online banking home page.

At step 816, the pre-payment platform computer system 160 may instruct the pre-payment platform's financial institution 162 to perform the transfer of money to the receiving financial institution. The instruction may reference the one-time transaction number. As shown as Activity F7 in FIG. 7, upon receipt of the instruction of step 816, the pre-payment platform financial institution may transmit the payment to the receiving financial institution via a dedicated, private data communication line that is independent of and separate from a public communication network such as the Internet. The payment may be performed via conventional financial institution payment channels, such as “Swift” and the like. The payment may be accompanied by the one-time transaction number. The receiving financial institution may match the one-time transaction number included with the payment against the one-time transaction number associated with the user 102. When the one-time transaction numbers match, the payment may then be credited to the appropriate recipient account within the recipient financial institution, at step 818.

As shown in FIG. 7 as activity G7, the CRM call center and help module 110 of the transaction facilitation system may be accessed by the user 102 if there is an incomplete or improper performance of the transaction. In an exemplary embodiment, the user 102 may contact the CRM call center via the user's financial institution computer system 106, for instance, via an electronic email address and/or communication application accessible through a web page of the user's financial institution. Alternatively, the CRM call center and help module 110 may be accessed via telephone, facsimile, email, postal mail, and the like. In an exemplary embodiment, access and/or utilization of the CRM services may require provision of the CRM password.

A record of each transaction may be generated and stored by the transaction facilitation computer system 104 at step 820, as shown in Activity H7 of FIG. 7. The record may include information corresponding to the transaction including user identity, vendor, purchase amount, purchase date, financial institution, delivery date, and the like. In an exemplary embodiment, a transaction record may be stored for a predetermined period of time, for example 7 years, in a secure database 132 that is not accessible or connected to a public network such as the Internet, and that is not connected to other storage devices 130 of the facilitation computer system 104.

It should be understood that the present invention is not limited to the precise illustrative exemplary embodiments described herein, and that various changes and modifications may be effected by one skilled in the art without departing from the spirit or scope of the invention. For example, elements and/or features of different illustrative embodiments may be combined with each other and/or substituted for each other within the scope of the present disclosure and the appended claims. In addition, improvements and modifications which become apparent to persons of ordinary skill in the art after reading the present disclosure, the drawings, and the appended claims are deemed within the spirit and scope of the present application.

What is claimed is:

1. A method of facilitating a secure transaction over communication networks, comprising the steps of:
receiving information associated with a user via a secure communication network;
generating a unique transaction number;
receiving transaction type information via the secure communication network;
providing product information from a computer system of a vendor to the user via the secure communication network;
receiving selected product identification information from the user via the secure communication network;
transmitting selected transaction information and the generated unique transaction number to a financial institution of the user via the secure communication network;
receiving transaction confirmation information from the financial institution of the user via the secure communication network;
transmitting a purchase order and the generated unique transaction number to the vendor via the secure communication network;
receiving a confirmation of the purchase order from the vendor via the secure communication network; and
transmitting an indication of the confirmation of the purchase order, the transaction number, and a customer relations management password to the financial institution of the user.

2. The method of claim 1, further comprising transmitting a payment from the financial institution of the user to a financial institution of the vendor, wherein
a quantity of the payment is based upon the selected transaction information.

3. The method of claim 1, wherein
the information associated with the user includes at least one of a name of the financial institution of the user, a country of domicile of the financial institution of the user, or an electronic mail address of the user.

4. The method of claim 1, wherein
the transaction type is one of commercial or financial.

5. The method of claim 1, wherein
the secure communication network includes a dedicated data communication line that is not connected to a public communication network.

6. The method of claim 1, wherein
the product information provided to the user includes a web page of the vendor; and
the product information is presented via a web browser application running on a computer system of the user.

7. The method of claim 6, wherein
the product information further includes information associated with product prices, product specifications, product appearance, product quantity, product function, and product shipping information.

8. The method of claim 1, wherein
the financial institution of the user includes at least one of a bank, a credit card issuer, or a debit card issuer.

9. The method of claim 1, wherein
the transaction confirmation information is transmitted from the financial institution upon instruction from the user.

10. The method of claim 1, wherein
the customer relations management password is operable for allowing access to a customer relations management help center for resolution of problems associated with the transaction.

11. A method of facilitating a secure transaction over communication networks, comprising the steps of:
receiving information associated with a user via a secure communication network;
receiving information associated with a vendor via the secure communication network;
receiving information associated with the transaction via the secure communication network;
generating a unique transaction number;
transmitting selected transaction information and the generated unique transaction number to a financial institution of the user via the secure communication network;
receiving transaction confirmation information from the financial institution of the user via the secure communication network;
transmitting a purchase order to the vendor via the secure communication network;
receiving a confirmation of the purchase order from the vendor via the secure communication network; and
transmitting an indication of the confirmation of the purchase order, the transaction number, and a customer relations management password to the financial institution of the user.

12. The method of claim 11, further comprising transmitting a payment from the financial institution of the user to a financial institution of the vendor, wherein
a quantity of the payment is associated with the selected transaction information.

13. The method of claim 11, wherein
the information associated with the user includes at least one of a name of the financial institution of the user, a country of domicile of the financial institution of the user, or an electronic mail address of the user.

14. The method of claim 11, wherein
the information of the vendor includes at least one of a name of the vendor or an address of an Internet web site of the vendor.

15. The method of claim 11, wherein
the information associated with the transaction includes at least one of a date of the transaction, a time of the transaction, an amount of the transaction, a currency of the transaction, or selected item identification information.

16. The method of claim 15, wherein
the selected item identification information includes information associated with product prices, product specifications, product appearance, product quantity, product function, and product shipping information.

17. The method of claim 11, wherein
the secure communication network includes a dedicated data communication line that is not connected to a public communication network.

18. The method of claim 11, wherein
the financial institution of the user includes at least one of a bank, a credit card issuer, or a debit card issuer.

19. The method of claim 11, wherein
the transaction confirmation information is transmitted from the financial institution upon instruction from the user.

20. The method of claim 11, wherein
the customer relations management password is operable for allowing access to a customer relations management help center for resolution of problems associated with the transaction.

21. A method of facilitating a secure transaction over communication networks, comprising the steps of:
receiving information associated with a user via a secure communication network;
generating a unique transaction number;
receiving transaction type information, pre-payment platform identification information, and transaction quantity information from the user via the secure communication network;
transmitting transaction information to the pre-payment platform via the secure communication network;
receiving transaction confirmation information from the pre-payment platform via the secure communication network; and
transmitting an indication of the transaction confirmation, the transaction quantity information, the generated unique transaction number, and a customer relations management password to a financial institution of the user via the secure communication network.

22. The method of claim 21, further comprising transmitting a payment and the unique transaction number from a financial institution of the pre-payment platform to the financial institution of the user via the secure communication network, wherein
a quantity of the payment is determined based upon the transaction quantity information received from the user.

23. The method of claim 21, wherein
the information associated with the user includes at least one of a name of the financial institution of the user, a country of domicile of the financial institution of the user, or an electronic mail address of the user.

24. The method of claim 21, wherein
the transaction information includes pre-payment account identification information, the transaction quantity information, a name of a receiving financial institution, a country of domicile of the receiving financial institution, and the generated unique transaction number.

25. The method of claim 21, wherein
the transaction type is one of commercial or financial;
the financial transaction type is one of bank or pre-payment platform; and
the pre-payment transaction type is one of payment or retrieval of money.

26. The method of claim 21, wherein
the secure communication network includes a dedicated data communication line that is not connected to a public communication network.

27. The method of claim 21, wherein
the financial institution of the user includes at least one of a bank, a credit card issuer, or a debit card issuer.

28. The method of claim 21, wherein
the customer relations management password is operable for allowing access to a customer relations management help center for resolution of problems associated with the transaction.

29. A method of facilitating a secure transaction over communication networks, comprising the steps of:
receiving information associated with a user via a secure communication network;
generating a unique transaction number;
receiving transaction type information, pre-payment platform identification information, beneficiary account identification information, and transaction quantity information from the user via the secure communication network;
transmitting transaction information to a financial institution of the user via the secure communication network;
receiving transaction confirmation information from the financial institution of the user via the secure communication network;
transmitting an indication of the transaction confirmation, the generated unique transaction number, and the beneficiary account identification information to a pre-payment platform; and
transmitting an indication of the transaction status and a customer relations management password to the financial institution of the user via the secure communication network.

30. The method of claim 29, further comprising transmitting a payment and the unique transaction number from the financial institution of the user to a financial institution of the pre-payment platform via the secure communication network, wherein
a quantity of the payment is based upon the transaction quantity information provided by the user.

31. The method of claim 29, wherein
the information associated with the user includes at least one of a name of the financial institution of the user, a country of domicile of the financial institution of the user, or an electronic mail address of the user.

32. The method of claim 29, wherein
the transaction information includes the transaction quantity information and the generated unique transaction number.

33. The method of claim 29, wherein
the transaction type is one of commercial or financial;
the financial transaction type is one of bank or pre-payment platform; and
the pre-payment transaction type is one of payment or retrieval of money.

34. The method of claim 29, wherein
the secure communication network includes a dedicated data communication line that is not connected to a public communication network.

35. The method of claim 29, wherein
the financial institution of the user includes at least one of a bank, a credit card issuer, or a debit card issuer.

36. The method of claim 29, wherein
the customer relations management password is operable for allowing access to a customer relations management help center for resolution of problems associated with the transaction.
